(19) United States
(12) Patent Application Publication
(10) Pub. No.: US 2012/0324795 A1
(43) Pub. Date: Dec. 27, 2012

(54) HINGE ASSEMBLY HAVING AN UP STOP DAMPING MECHANISM FOR ROTATABLY SUPPORTING A DECKLID OF A VEHICLE

(75) Inventors: Gary W. Krajenke, Warren, MI (US); Alvin N. Standard, Clarkston, MI (US)

(73) Assignee: GM GLOBAL TECHNOLOGY OPERATIONS LLC, Detroit, MI (US)

(21) Appl. No.: 13/167,077

(22) Filed: Jun. 23, 2011

(51) Int. Cl. E05D 7/00; B60J 5/00

(52) U.S. Cl. 49/381; 16/221

(57) ABSTRACT

A hinge assembly for rotatably supporting a decklid relative to a body of a vehicle includes a damping mechanism for damping movement of the decklid relative to the body. The damping mechanism includes a damping clip attached to a bracket of the hinge assembly, and a damping bumper attached to a hinge box of the hinge assembly. Movement of the bracket from a closed position into an open position brings the damping bumper into engagement with the damping clip. The damping bumper spreads and/or elastically deforms the damping clip to absorb energy and dampen the movement of the bracket and/or the decklid.

### TECHNICAL FIELD

The invention generally relates to a hinge assembly for rotatably supporting a decklid of a vehicle, and more specifically to a hinge assembly having an up stop damping mechanism for damping upward movement of the decklid while opening the decklid, and for resisting downward movement of the decklid once opened.

### BACKGROUND

Vehicles include a decklid for closing a cargo area of the vehicle, e.g., a trunk. A hinge assembly rotatably attaches the decklid to the vehicle. Upon un-latching the decklid, the decklid is free to rotate from a closed position upward into an open position. Many hinge assemblies are counter-balanced, or include other opening mechanisms, to automatically raise the decklid once un-latched, thereby automatically raising the decklid into the open position. When automatically opening, the decklid and components of the hinge assembly move with a velocity, thereby generating momentum, i.e., energy, in the decklid and components of the hinge assembly. If the decklid and the attached components of the hinge assembly come to an abrupt stop upon reaching the open position, the decklid will often bounce back downward. This bounce back is often referred to as a “bobble” effect, and may be undesirable to users.

### SUMMARY

A hinge assembly for a vehicle is provided. The hinge assembly includes a hinge box that is configured for attachment to a body of the vehicle. A bracket is rotatably coupled to the hinge box. The bracket rotates between a closed position and an open position about a rotation axis. The hinge assembly includes a damping mechanism that is configured for damping movement of the bracket between the closed position and the open position. The damping mechanism includes a damping clip attached to one of the bracket and the hinge box. The damping clip includes a wall that defines a receiving cavity. The receiving cavity extends a depth along a central cavity axis, and has a minimum cavity width perpendicular to the central cavity axis. A damping bumper is attached to one of the bracket and the hinge box. The damping bumper includes a projection having a maximum projection width that is greater than the minimum cavity width. Rotation of the bracket about the rotation axis from the closed position into the open position moves one of the projection and the receiving cavity into engagement with the other of the projection and the receiving cavity. The maximum projection width biases the wall of the damping clip outward to absorb energy and dampen the movement of the bracket as the maximum projection width of the projection moves past the minimum cavity width of the receiving cavity along the central cavity axis.

A vehicle is also provided. The vehicle includes a body defining an opening. A hinge assembly rotatably interconnects a decklid to the body for rotation between an open position and a closed position about a rotation axis. The hinge assembly includes a hinge box that is attached to the body. A bracket is rotatably coupled to the hinge box for rotation about the rotation axis between the closed position and the open position. The bracket supports the decklid. The hinge assembly further includes a damping mechanism that is configured for damping movement of the bracket between the closed position and the open position, and for resisting movement of the bracket from the open position into the closed position. The damping mechanism includes a damping clip that is attached to one of the bracket and the hinge box. The damping clip includes a wall defining a receiving cavity. The receiving cavity extends a depth along a central cavity axis and has a minimum cavity width perpendicular to the central cavity axis. A damping bumper is attached to one of the bracket and the hinge box. The damping bumper includes a projection having a maximum projection width that is greater than the minimum cavity width. Rotation of the bracket about the rotation axis from the closed position into the open position moves one of the projection and the receiving cavity into engagement with the other of the projection and the receiving cavity. The maximum projection width biases the wall of the damping clip outward to absorb energy and dampen the movement of the bracket as the maximum projection width of the projection moves past the minimum cavity width of the receiving cavity along the central cavity axis. The wall of the damping clip includes a thickness, with an energy absorption profile of the damping mechanism dependent upon the thickness of the wall.

Accordingly, the damping mechanism absorbs energy of the moving decklid and/or bracket to bring the decklid and/or bracket to a stop when moving from the closed position into the open position, i.e., an opening operation, thereby preventing any bobble, i.e., bounce back, of the decklid and/or bracket. The damping mechanism absorbs the energy by spreading the receiving cavity of the damping clip. The receiving cavity is spread by the projection, which is brought into wedging contact with the receiving cavity of the damping clip by the opening movement of the decklid and/or the bracket. Additionally, the damping mechanism resists movement of the decklid and/or the bracket from moving from the open position into the closed position, i.e., a closing operation, thereby increasing a holding force applied to the decklid to keep the decklid in the open position. Because the damping mechanism is built into and attached to the components of the hinge assembly, the damping mechanism is free from any affects caused by variations in the build of the body of the vehicle.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of a vehicle.

FIG. 2 is a schematic perspective view of a hinge assembly of the vehicle.

FIG. 3 is a schematic cross sectional view of the hinge assembly.

FIG. 4 is a schematic plan view of a damping mechanism showing a projection of the damping mechanism entering a receiving cavity of the damping mechanism.

FIG. 5 is a schematic plan view of the damping mechanism in an open position of the hinge assembly showing the projection fully inserted into the receiving cavity.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

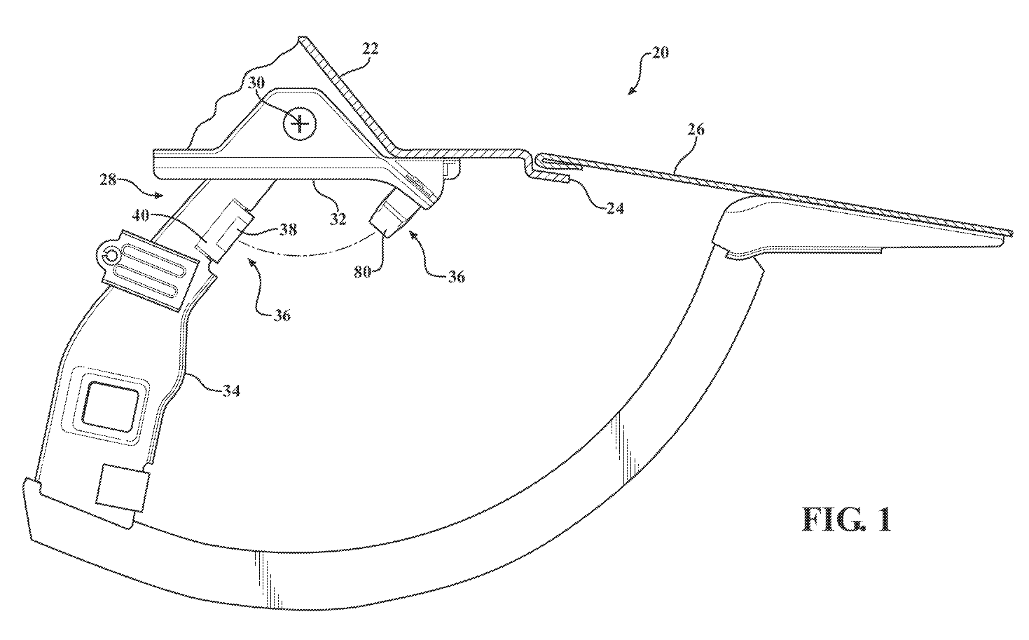

Referring to the Figures, wherein like numerals indicate like parts throughout the several views, a vehicle is generally shown at 20. Referring to FIG. 1, the vehicle 20 includes a body 22 that defines an opening 24. The opening 24 may provide access, for example, to a trunk or other cargo area of the vehicle 20. A decklid 26 is configured for closing the opening 24, and is moveable between a closed position sealing the opening 24, and an open position allowing access to the cargo area through the opening 24. A hinge assembly 28 rotatably interconnects the decklid 26 and the body 22. The hinge assembly 28 rotatably supports the decklid 26 for rotation about a rotation axis 30 between the open position and the closed position.

The hinge assembly 28 includes a hinge box 32 that is configured for attachment to the body 22 of the vehicle 20. The hinge box 32 may be attached to the body 22 in any suitable manner. For example, the hinge box 32 may be attached to the body 22 with one or more fasteners, including but not limited to bolts, screws, etc. A bracket 34 is rotatably coupled to the hinge box 32. The bracket 34 is rotatable relative to the hinge box 32 about the rotation axis 30 for rotation between the closed position and the open position. The decklid 26 is secured to and moveable with the bracket 34. The decklid 26 may be attached to the bracket 34 in any suitable manner. The bracket 34 may be shaped and/or configured in any suitable manner, and may include but is not limited to a counterbalanced bracket 34 designed to automatically move the decklid 26 from the closed position into the open position upon the decklid 26 being un-latched.

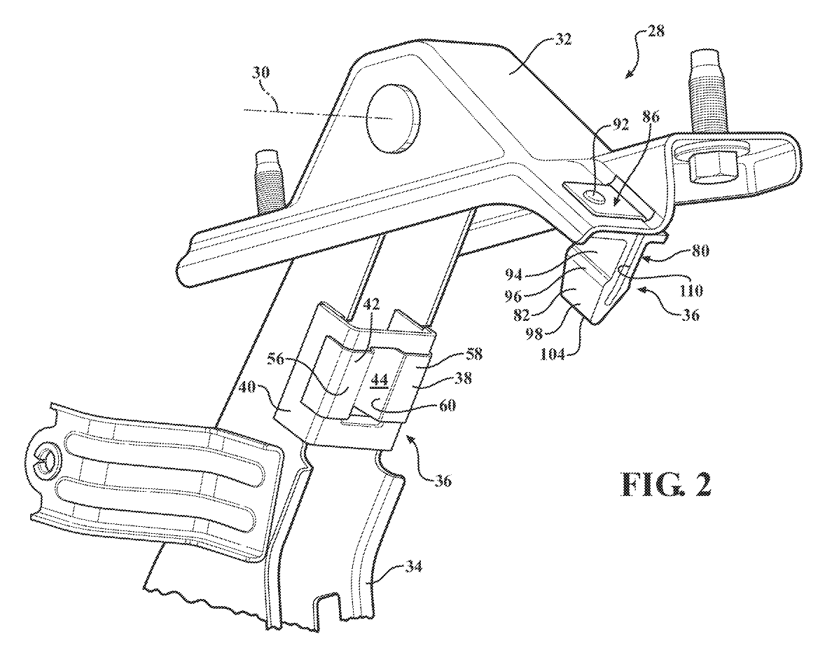

Referring also to FIG. 2, the hinge assembly 28 further includes a damping mechanism 36. The damping mechanism 36 is configured for damping movement of the bracket 34 and the decklid 26 between the closed position and the open position. The damping mechanism 36 includes a damping clip 38 that is attached to one of the bracket 34 and the hinge box 32. As shown, the damping clip 38 is attached to the bracket 34. The damping clip 38 may be attached to the bracket 34 and/or the hinge box 32 in any suitable manner. As shown, a retaining clip 40 interconnects the damping clip 38 and the bracket 34. The retaining clip 40 may be welded or otherwise affixed to the bracket 34, and the damping clip 38 may be welded or otherwise affixed to the retaining clip 40. It should be appreciated that the damping clip 38 may be attached to the bracket 34 or the hinge box 32 in some other manner not shown or described herein.

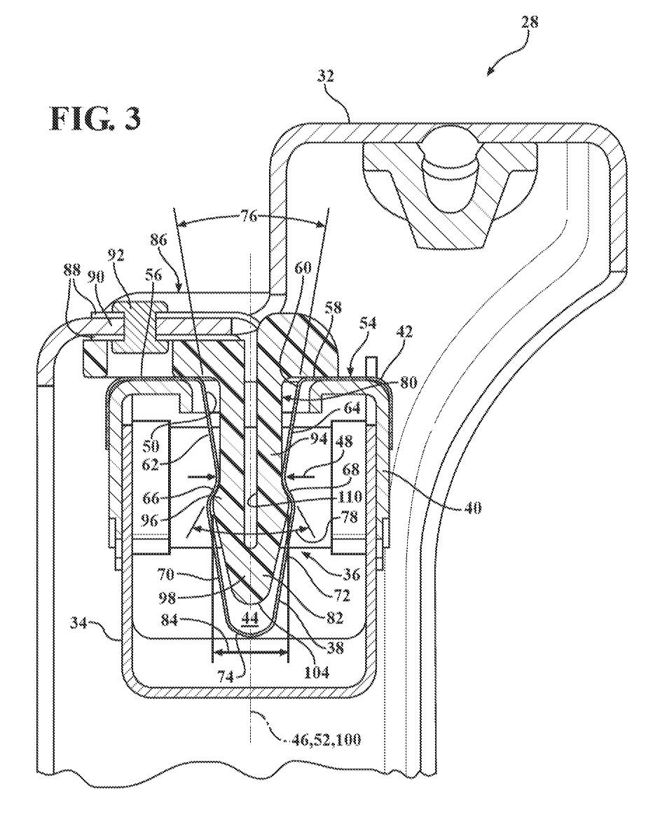

Referring to FIGS. 3, 4 and 5, the damping clip 38 includes a wall 42. The wall 42 may include a planar strip of material formed to define a receiving cavity 44. The receiving cavity 44 extends a depth along a central cavity axis 46, and includes a minimum cavity width 48 measured perpendicular to the central cavity axis 46 and spanning across the receiving cavity 44. The wall 42 of the damping clip 38 may include and be manufactured from a piece of flat spring steel. However, it should be appreciated that the wall 42 may include and be manufactured from some other material, and include some other shape. Additionally, the damping clip 38 may include a coating 50 disposed thereon that is configured for increasing a surface friction of the wall 42. For example, the coating 50 may include a polymer or elastomer material having a coefficient of friction greater than the material used to manufacture the damping clip 38.

The central cavity axis 46 lies along a mirror plane 52 of the damping clip 38, with the damping clip 38 defining mirror images across the mirror plane 52. The wall 42 of the damping clip 38 includes a base portion 54. A planar surface of the base portion 54 is disposed perpendicular relative to the rotation axis 30 of the hinge assembly 28, with the receiving cavity 44 and the central cavity axis 46 extending perpendicularly relative to the base portion 54 of the wall 42. The base portion 54 includes a first half 56 and a second half 58. The first half 56 and the second half 58 are disposed opposite each other across an opening 60 of the receiving cavity 44, and are mirror images of each other across the mirror plane 52. A first guide portion 62 extends from the first half 56 of the base portion 54 along and toward the central cavity axis 46, and a second guide portion 64 extends from the second half 58 of the base portion 54 along and toward the central cavity axis 46. The first guide portion 62 and the second guide portion 64 are mirror images of each other across the mirror plane 52. A first expanding portion 66 extends from the first guide portion 62 along and away from the central cavity axis 46, and a second expanding portion 68 extends from the second guide portion 64 along and away from the central cavity axis 46. The first expanding portion 66 and the second expanding portion 68 are mirror images of each other across the mirror plane 52. A first end portion 70 extends from the first expanding portion 66 along and toward the central cavity axis 46, and a second end portion 72 extends from the second expanding portion 68 along and toward the central cavity axis 46. The first end portion 70 and the second end portion 72 are mirror images of each other across the mirror plane 52. A hinge portion 74 extends between and connects the first end portion 70 and the second end portion 72.

The first guide portion 62 and the second guide portion 64 converge toward the central cavity axis 46 and/or the mirror plane 52 to define an entrance angle 76 therebetween. The first expanding portion 66 and the second expanding portion 68 diverge from the first guide portion 62 and the second guide portion 64 respectively away from the central cavity axis 46 to define an exit angle 78 therebetween. Preferably, the entrance angle 76 is less than the exit angle 78. The entrance angle 76 may include an angle between the range of ten degrees (10°) and forty degrees (40°). The exit angle 78 may include an angle between the range of forty degrees (40°) and seventy five degrees) (75°. However, the values of the entrance angle 76 and the exit angle 78 may vary from the values provided above, and are dependent upon the design forces available in the components, the coefficient of friction available in the materials and coatings selected, and the available packaging requirements. Shallow or smaller angles provide lower engaging forces, but require more linear travel, whereas larger angles provide higher engaging forces and require less linear travel.

The damping mechanism 36 further includes a damping bumper 80. The damping bumper 80 is attached to one of the bracket 34 and the hinge box 32. More specifically, the damping bumper 80 is attached to the one of the bracket 34 and the hinge box 32 to which the damping clip 38 is not attached to, i.e., the damping clip 38 is attached to one of the bracket 34 and the hinge box 32 and the damping bumper 80 is attached to the other of the bracket 34 and the hinge box 32. As shown, the damping bumper 80 is attached to the hinge box 32 and the damping clip 38 is attached to the bracket 34. However, it should be appreciated that the damping bumper 80 may be attached to the bracket 34, and the damping clip 38 may be attached to the hinge box 32.

The damping bumper 80 includes a projection 82. The projection 82 includes a maximum projection width 84 that is greater than the minimum cavity width 48. The projection 82 is oriented for engaging and slideable insertion into the receiving cavity 44 of the damping clip 38. The damping bumper 80 includes an attachment mechanism 86 that is configured for supporting the projection 82 and securing the damping bumper 80 to one of the bracket 34 or the hinge box 32. As shown, the attachment mechanism 86 includes a pair of opposing plates 88 disposed in spaced relationship for receiving a structural element 90 therebetween. A rivet 92 or other similar fastening device extends through each of the pair of opposing plates 88 and the structural element 90 to secure the damping bumper 80 in place. It should be appreciated that the attachment mechanism 86 may be configured other than shown and described herein.

The projection 82 of the damping bumper 80 includes a body portion 94, a tapered neck portion 96 and a wedge portion 98. As shown, the body portion 94 is attached to the pair of opposing plates 88 of the attachment mechanism 86, and extends along a central body plane 100. The body portion 94 includes a uniform body width that is measured perpendicular relative to the central body plane 100. The body width is equal to or greater than the minimum cavity width 48. The tapered neck portion 96 extends from the body portion 94 to the wedge portion 98, and the wedge portion 98 extends from the tapered neck portion 96 to a distal end 104. The tapered neck portion 96 includes a variable neck width measured perpendicular relative to the central body plane 100. The variable neck width increases as the tapered neck portion 96 extends from the body portion 94 to the wedge portion 98. The wedge portion 98 includes a variable wedge width measured perpendicular relative to the central body plane 100. The variable wedge width decreases as the wedge portion 98 extends from the tapered neck portion 96 to the distal end 104. The projection 82 of the damping bumper 80 may further include a slot 110 extending axially through the projection 82 along the central body plane 100.

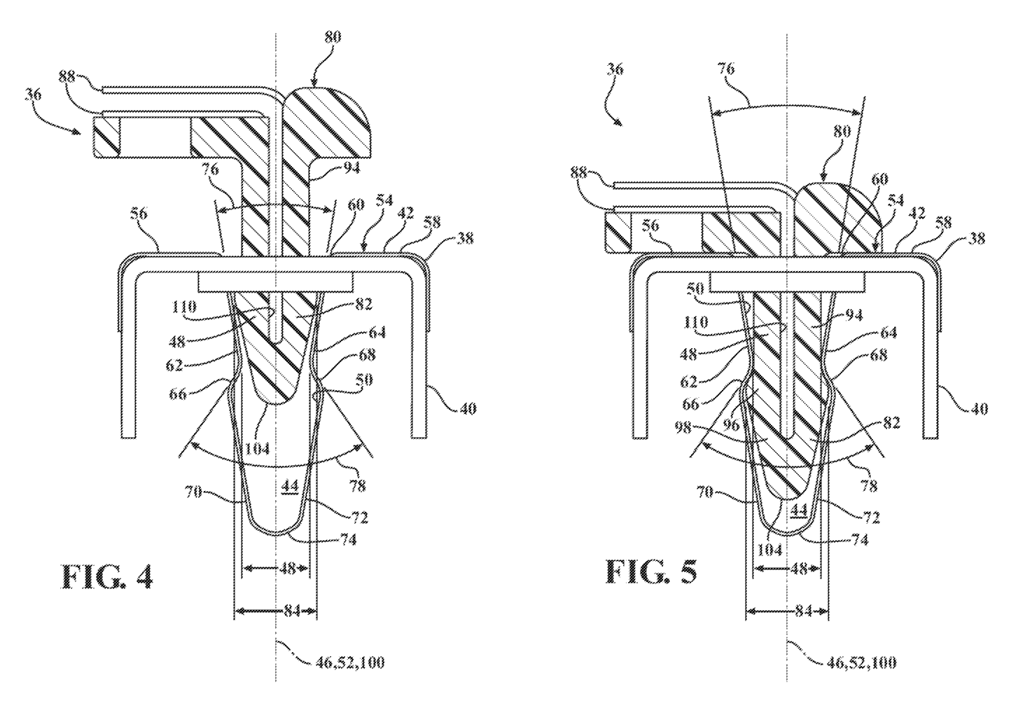

Rotation of the bracket 34 and the decklid 26 about the rotation axis 30 from the closed position into the open position, i.e., an opening operation, moves one of the projection 82 and the receiving cavity 44 into engagement with the other of the projection 82 and the receiving cavity 44. As shown, the opening operation moves the damping clip 38 into engagement with the damping bumper 80. However, it should be appreciated that the relative positions of the damping clip 38 and the damping bumper 80 may be reversed, with the opening operating moving the damping bumper 80 into engagement with the damping clip 38. Referring to FIG. 4, upon the damping bumper 80 engaging the damping clip 38, the wedge portion 98 of the projection 82 enters the receiving cavity 44 and engages the first guide portion 62 and the second guide portion 64 at the entrance angle 76 to spread and/or elastically deform the wall 42 of the damping clip 38. As the wedge portion 98 engages the first guide portion 62 and the second guide portion 64, the maximum projection width 84 of the projection 82 biases the wall 42 of the damping clip 38 outward to deform the wall 42. This deformation operates to absorb energy and dampen the movement of the bracket 34 and the decklid 26 as the maximum projection width 84 of the projection 82 moves past the minimum cavity width 48 of the receiving cavity 44 along the central cavity axis 46. The energy that is absorbed by the damping clip 38 decreases the velocity of the bracket 34 and the decklid 26. The bracket 34 may then rotate further until the projection 82 is fully disposed within the receiving cavity 44, whereby the upward movement of the decklid 26 and the bracket 34 stops without bouncing back downward, i.e., without bobble.

The rate at which energy is absorbed through the deformation of the damping clip 38 and the rate at which the movement of the bracket 34 and the decklid 26 are dampened are dependent upon the entrance angle 76. A larger value of the entrance angle 76 increases the rate of energy absorption and the rate of damping thereby providing a faster and more abrupt stop to the opening operation and/or movement of the bracket 34 and the decklid 26, whereas a smaller value of the entrance angle 76 decreases the rate of energy absorption and the rate of damping thereby providing a slower and more gradual stop to the opening operation and/or movement of the bracket 34 and the decklid 26. Additionally, if the wall 42 of the damping clip 38 is coated with a high friction coating 50, the increased friction further operates to increase the amount of energy absorbed by the damping mechanism 36. Furthermore, if the projection 82 includes the slot 110, the projection 82 may elastically deform inward toward the central body plane 100, thereby further increasing the amount of energy absorbed by the damping mechanism 36.

Referring to FIG. 5, once the projection 82 is fully inserted into the receiving cavity 44, the tapered neck portion 96 of the damping bumper 80 engages the first expanding portion 66 and the second expanding portion 68 of the damping clip 38 at the exit angle 78. The interaction between the tapered neck portion 96, the first expanding portion 66 and the second expanding portion 68 at the exit angle 78 resists movement of the bracket 34 and the decklid 26 from the open position into the closed position, i.e., a closing operation. The resistance to the closing operation thereby supplements a holding force for holding the decklid 26 in the open position. In order to close the decklid 26, the projection 82 must be withdrawn from the receiving cavity 44, which requires the tapered neck portion 96 to expand and/or elastically deform the wall 42 of the damping clip 38 to allow the maximum projection width 84 to pass the minimum cavity width 48. The exit angle 78 includes a larger angle than the entrance angle 76 so that the force required to withdraw the projection 82 from the receiving cavity 44 is greater than the force required to insert the projection 82 into the receiving cavity 44.

Referring to FIGS. 3, 4 and 5, the wall 42 of the damping clip 38 includes a thickness. The thickness of the wall 42 determines an energy absorption profile of the damping clip 38. The energy absorption profile varies with the thickness of the wall 42. An increase in the thickness of the wall 42 increases the amount of force required to deform the wall 42, and thereby increases the amount of energy absorbed by the damping mechanism 36, whereas a decrease in the thickness of the wall 42 decreases the amount of force required to deform the wall 42, and thereby decreases the amount of energy absorbed by the damping mechanism 36.

While the best modes for carrying out the invention have been described in detail, those familiar with the art to which this invention relates will recognize various alternative designs and embodiments for practicing the invention within the scope of the appended claims.

1. A hinge assembly for a vehicle, the hinge assembly comprising:
a hinge box configured for attachment to a body of the vehicle;
a bracket rotatably coupled to the hinge box for rotation between a closed position and an open position about a rotation axis; and
a damping mechanism configured for damping movement of the bracket between the closed position and the open position, the damping mechanism including:
a damping clip attached to one of the bracket and the hinge box and including a wall defining a receiving cavity extending a depth along a central cavity axis and having a minimum cavity width perpendicular to the central cavity axis;
a damping bumper attached to one of the bracket and the hinge box and including a projection having a maximum projection width that is greater than the minimum cavity width;
wherein rotation of the bracket about the rotation axis from the closed position into the open position moves one of the projection and the receiving cavity into engagement with the other of the projection and the receiving cavity; and
wherein the maximum projection width biases the wall of the damping clip outward to absorb energy and dampen the movement of the bracket as the maximum projection width of the projection moves past the minimum cavity width of the receiving cavity along the central cavity axis.

2. A hinge assembly as set forth in claim 1 wherein the wall of the damping clip includes:
a base portion having a first half and a second half separated by an opening to the receiving cavity;
a first guide portion extending from the first half of the base portion along and toward the central cavity axis;
a first expanding portion extending from the first guide portion along and away from the central cavity axis;
a first end portion extending from the first expanding portion along and toward the central cavity axis;
a second guide portion extending from the second half of the base portion along and toward the central cavity axis;
a second expanding portion extending from the second guide portion along and away from the central cavity axis;
a second end portion extending from the second expanding portion along and toward the central cavity axis; and
a hinge portion extending between the first end portion and the second end portion.

3. A hinge assembly as set forth in claim 2 wherein the first guide portion and the second guide portion converge toward the central cavity axis to define an entrance angle therebetween.

4. A hinge assembly as set forth in claim 3 wherein the entrance angle is between the range of ten degrees (10°) and forty degrees (40°).

5. A hinge assembly as set forth in claim 3 wherein the first expanding portion and the second expanding portion diverge from the first guide portion and the second guide portion respectively away from the central cavity axis to define an exit angle.

6. A hinge assembly as set forth in claim 5 wherein the exit angle is between the range of forty degrees (40°) and seventy five degrees (75°).

7. A hinge assembly as set forth in claim 5 wherein the entrance angle is less than the exit angle.

8. A hinge assembly as set forth in claim 2 wherein the projection of the damping bumper includes:
a body portion extending along a central body axis and including a uniform body width perpendicular relative to the central body axis;
a tapered neck portion extending from the body portion; and
a wedge portion extending from the tapered neck portion to a distal end;
wherein the tapered neck portion includes a variable neck width perpendicular relative to the central body axis that increases from the body portion to the wedge portion; and
wherein the wedge portion includes a variable wedge width perpendicular relative to the central body axis that decreases from the tapered neck portion to the distal end.

9. A hinge assembly as set forth in claim 8 wherein the body width is equal to or greater than the minimum cavity width.

10. A hinge assembly as set forth in claim 8 wherein the damping bumper includes a slot extending axially through the projection along the central body axis.

11. A hinge assembly as set forth in claim 8 wherein the tapered neck portion of the damping bumper engages the first expanding portion and the second expanding portion of the damping clip to resist movement of the bracket from the open position into the closed position.

12. A hinge assembly as set forth in claim 8 wherein the damping bumper includes an attachment mechanism attached to the body portion of the projection and configured for securing the damping bumper to the hinge box.

13. A hinge assembly as set forth in claim 1 wherein the wall of the damping clip includes and is manufactured from a spring steel.

14. A hinge assembly as set forth in claim 12 wherein the damping clip includes a coating configured for increasing a surface friction of the wall.

15. A hinge assembly as set forth in claim 1 wherein the wall of the damping clip includes a thickness, wherein an energy absorption profile is varies with the thickness of the wall.

16. A hinge assembly as set forth in claim 1 further comprising a retaining clip interconnecting the damping clip and the bracket.

17. A vehicle comprising:
a body defining an opening;
a hinge assembly rotatably interconnecting a decklid to the body for rotation about a rotation axis between an open position and a closed position, wherein the hinge assembly includes:
a hinge box attached to the body;
a bracket rotatably coupled to the hinge box for rotation about the rotation axis between the closed position and the open position and supporting the decklid; and
a damping mechanism configured for damping movement of the bracket between the closed position and the open position, and for resisting movement of the bracket from the open position into the closed position, the damping mechanism including:
a damping clip attached to one of the bracket and the hinge box and including a wall defining a receiving cavity extending a depth along a central cavity axis and having a minimum cavity width perpendicular to the central cavity axis;
a damping bumper attached to one of the bracket and the hinge box and including a projection having a maximum projection width that is greater than the minimum cavity width;
wherein rotation of the bracket about the rotation axis from the closed position into the open position moves one of the projection and the receiving cavity into engagement with the other of the projection and the receiving cavity;
wherein the maximum projection width biases the wall of the damping clip outward to absorb energy and dampen the movement of the bracket as the maximum projection width of the projection moves past the minimum cavity width of the receiving cavity along the central cavity axis; and
wherein the wall of the damping clip includes a thickness, with an energy absorption profile dependent upon the thickness of the wall.

18. A vehicle as set forth in claim 17 wherein the wall of the damping clip includes:
a base portion having a first half and a second half separated by an opening to the receiving cavity;
a first guide portion extending from the first half of the base portion along and toward the central cavity axis;
a first expanding portion extending from the first guide portion along and away from the central cavity axis;
a first end portion extending from the first expanding portion along and toward the central cavity axis;
a second guide portion extending from the second half of the base portion along and toward the central cavity axis;
a second expanding portion extending from the second guide portion along and away from the central cavity axis;
a second end portion extending from the second expanding portion along and toward the central cavity axis; and
a hinge portion extending between the first end portion and the second end portion.

19. A vehicle as set forth in claim 18 wherein the projection of the damping bumper includes:
a body portion extending along a central body axis and including a uniform body width perpendicular relative to the central body axis;
a tapered neck portion extending from the body portion; and
a wedge portion extending from the tapered neck portion to a distal end;
wherein the tapered neck portion includes a variable neck width perpendicular relative to the central body axis that increases from the body portion to the wedge portion; and
wherein the wedge portion includes a variable wedge width perpendicular relative to the central body axis that decreases from the tapered neck portion to the distal end.

20. A vehicle as set forth in claim 19 wherein:
the first guide portion and the second guide portion converge toward the central cavity axis to define an entrance angle between the range of ten degrees (10°) and forty degrees (40°);
the first expanding portion and the second expanding portion diverge from the first guide portion and the second guide portion respectively away from the central cavity axis to define and exit angle between the range of forty degrees (40°) and seventy five degrees (75°);
the wedge portion of the projection engages the first guide portion and the second guide portion at the entrance angle to spread the damping clip when the bracket moves from the closed position into the open position; and
wherein the neck portion of the projection engages the first expanding portion and the second expanding portion at the exit angle to spread the damping clip and allow withdrawal of the projection from the receiving cavity.
